(19) United States
(12) Patent Application Publication
(10) Pub. No.: US 2026/0011122 A1
(43) Pub. Date: Jan. 8, 2026

(54) PATCH FEATURE LEARNING METHOD FOR ANOMALY DETECTION, AND SYSTEM THEREFOR

(71) Applicant: LG MANAGEMENT DEVELOPMENT INSTITUTE CO., LTD., Seoul (KR)

(72) Inventors: Jee Ho HYUN, Seoul (KR); Sang Yun KIM, Gyeonggi-do (KR); Gi Young JEON, Seoul (KR); Seung Hwan KIM, Gyeonggi-do (KR); Kyung Hoon BAE, Seoul (KR); Byung Jun KANG, Gyeonggi-do (KR)

(21) Appl. No.: 19/323,509

(22) Filed: Sep. 9, 2025

Related U.S. Application Data
(63) Continuation of application No. PCT/KR2024/003119, filed on Mar. 11, 2024.

(30) Foreign Application Priority Data
Mar. 9, 2023 (KR) 10-2023-0030860

(51) Int. Cl. G06V 10/771; G06T 7/00; G06V 10/44; G06V 10/74; G06V 10/82

(52) U.S. Cl. CPC G06V 10/771; G06T 7/0008; G06V 10/44; G06V 10/761; G06V 10/82; G06T 2207/30164

(57) ABSTRACT

A patch feature learning method and a patch feature learning system for anomaly detection perform patch feature-based learning on a predetermined pretrained model based on an image data set for an anomaly detection target. The method and the system may acquire a feature map according to a first image data set; acquire a plurality of patch features based on local data in a predetermined image, based on the acquired feature map; perform feature representation learning based on the plurality of acquired patch features; acquire a reconstructing patch feature based on the performed feature representation learning; and perform anomaly detection based on the acquired reconstructing patch feature.

### CROSS REFERENCE TO RELATED APPLICATION(S)

This application is a continuation of International Application No. PCT/KR2024/003119, filed on Mar. 11, 2024, which claims the priority to Korean Patent Application No. 10-2023-0030860, filed on Mar. 9, 2023, which are all hereby incorporated by reference in their entireties.

### TECHNICAL FIELD

The present disclosure generally relates to a patch feature learning method and a patch feature learning system for anomaly detection. More specifically, some embodiments of the present disclosure relate to a patch feature learning method and system for performing patch feature-based learning on a pretrained model based on an image data set for an anomaly detection target.

### BACKGROUND

Anomaly detection may refer to a process of identifying abnormal patterns, anomalies, and/or exceptions from given data.

The anomaly detection may be a process of detecting components that deviate from properties of normal data.

For example, systems for the anomaly detection have been used in various application fields where identification of abnormal patterns is important, such as process monitoring, security intrusion detection, fraud identification, and/or medical diagnosis.

However, when data required for model learning for the anomaly detection is relatively rare or diverse and insufficient, such as a case in which it is difficult to collect abnormal data including a certain defect, a case in which labeled data is limited or a case in which additional training is required on a large amount of data having no label, there may be limitations on task processing performance for the anomaly detection based on the limited given data.

In addition, in a vision inspection field, the anomaly detection based on a specific image has been used. However, the images used in the vision inspection fields are high-dimensional data. Accordingly, when all data for the entire image is used at once to detect the anomaly, the resource for data processing and computation may be inefficient.

Additionally, the anomaly is observed as an abnormal pattern appearing in various sizes and shapes in a small portion of an image. A conventional method may not provide, enough ability for identifying the a local pattern on the entire image.

Therefore, there is a need to develop a new technology that can further improve accuracy and efficiency in the anomaly detection even under limited environmental conditions, and can improve task processing performance accordingly.

### SUMMARY

A patch feature learning method and a patch feature learning system for anomaly detection according to some embodiments of the present disclosure may perform patch feature-based learning on a predetermined pretrained model based on an image data set for an anomaly detection target.

According to certain embodiments of the present disclosure, a patch feature learning method and a patch feature learning system for anomaly detection may perform patch feature-based learning to reduce a variance of mutually similar patch features and increase a difference in mutually heterogeneous patch features.

However, technical tasks to be achieved by the present disclosure and embodiments of the present disclosure are not limited to the technical tasks described above, and other technical tasks may exist.

According to an embodiment of the present disclosure, there is provided a patch feature learning method for anomaly detection. The method includes a step of acquiring a feature map based on a first image data set, a step of acquiring a plurality of patch features based on local data within a predetermined image, based on the acquired feature map, a step of performing feature representation learning, based on the plurality of acquired patch features, a step of acquiring a ReConPatch feature based on the performed feature representation learning, and a step of performing anomaly detection, based on the acquired ReConPatch feature. The ReConPatch feature is data obtained by reconstructing a feature representation corresponding to the plurality of patch features in accordance with similarity calculated based on the plurality of patch features.

In another aspect, the patch feature may be a feature extracted from a patch that specifies at least a partial region within the predetermined image.

In another aspect, the step of acquiring the plurality of patch features may include any one step from a step of acquiring a plurality of patches according to a predetermined patch size, based on a first image included in the first image data set and extracting a feature for each of the plurality of acquired patches, and a step of extracting a feature for the entire first image included in the first image data set and dividing all of the extracted features into a predetermined patch size.

In another aspect, the step of performing the feature representation learning, based on the plurality of patch features, may include a step of performing semi-supervised concept learning.

In another aspect, the step of performing the feature representation learning, based on the plurality of patch features, may include a step of performing the learning, based on a first network, which is a neural network for calculating similarity between predetermined features, and a second network, which is a neural network for realizing feature representation learning.

In another aspect, the first network and the second network may each include a feature representation layer, which is a layer for reconstructing feature representation according to a predetermined feature, and a space projection layer, which is a layer for projecting feature representation according to a predetermined feature into a feature representation space.

In another aspect, the step of performing the feature representation learning, based on the plurality of patch features, may further include a step of gradually distilling data according to a parameter of the second network into data according to a parameter of the first network, based on an exponential moving average algorithm.

In another aspect, the step of performing the feature representation learning, based on the plurality of patch features, may further include a step of projecting a first patch feature pair including a predetermined first patch feature and a predetermined second patch feature into the feature representation space, and a step of calculating pairwise similarity, which is data obtained by measuring similarity between the first patch feature and the second patch feature, based on the first patch feature pair projected into the feature representation space.

In another aspect, the step of performing the feature representation learning, based on the plurality of patch features, may further include a step of calculating contextual similarity, which is data obtained by measuring bidirectional similarity between the K-number of nearest neighbors for the first patch feature and the K-number of nearest neighbors for the second patch feature, based on the first patch feature pair projected into the feature representation space.

In another aspect, the step of performing the feature representation learning, based on the plurality of patch features, may further include a step of calculating integrated similarity, which is data obtained by linearly combining the calculated pairwise similarity and the contextual similarity.

In another aspect, the step of performing the feature representation learning, based on the plurality of patch features, may further include a step of training the second network, based on the calculated integrated similarity.

In another aspect, the step of training the second network, based on the integrated similarity, may include a step of training a second feature representation layer for mapping the first patch feature and the second patch feature to be separated or closer to each other on the feature representation space according to the integrated similarity.

In another aspect, the step of performing the anomaly detection may include a step of acquiring a first test sample image, a step of acquiring the ReConPatch feature according to the acquired first test sample image, and a step of performing the anomaly detection, based on the ReConPatch feature according to the feature representation learning and the ReConPatch feature according to the first test sample image.

In another aspect, the step of performing the anomaly detection may further include a step of generating an anomaly score map, based on the similarity between the ReConPatch feature according to the feature representation learning and the ReConPatch feature according to the first test sample image, and a step of performing the anomaly detection, based on the generated anomaly score map.

In another aspect, according to an embodiment of the present disclosure, the patch feature learning method for anomaly detection may further include a step of performing coreset sampling on the ReConPatch feature according to the feature representation learning, and a step of performing the anomaly detection, based on the ReConPatch feature on which the coreset sampling is performed.

Meanwhile, according to an embodiment of the present disclosure, there is provided a patch feature learning system for anomaly detection. The system includes at least one the memory, and at least one processor for reading out at least one application stored in the memory to perform patch feature learning for the anomaly detection. The processor acquires a feature map according to ae first image data set, acquires a plurality of patch features based on local data within a predetermined image, based on the acquired feature map, performs feature representation learning, based on the plurality of acquired patch features, acquires a ReConPatch feature, which is data obtained by reconstructing feature representation according to the plurality of patch features, in accordance with similarity calculated based on the plurality of patch features, in accordance with the performed feature representation learning, and performs the anomaly detection, based on the acquired ReConPatch feature.

Meanwhile, according to an embodiment of the present disclosure, there is provided a computing device including at least one the memory, and at least one processor for reading out at least one application stored in the memory to perform patch feature learning for anomaly detection. Commands of the processor include commands for executing a step of acquiring a feature map according to a first image data set, a step of acquiring a plurality of patch features based on local data within a predetermined image, based on the acquired feature map, a step of performing feature representation learning, based on the plurality of acquired patch features, a step of acquiring a ReConPatch feature, which is data obtained by reconstructing feature representation according to the plurality of patch features in accordance with similarity calculated based on the plurality of patch features, in accordance with the performed feature representation learning, and a step of performing anomaly detection, based on the acquired ReConPatch feature.

According to an embodiment of the present disclosure, a patch feature learning method and a patch feature learning system for anomaly detection may perform patch feature-based learning on a predetermined pretrained model based on an image data set for an anomaly detection target. Therefore, the patch feature learning method and the patch feature learning system according to an embodiment of the present disclosure may perform more efficient data processing and provide an anomaly detection model that further improves task processing performance and quality for the anomaly detection.

In addition, according to an embodiment of the present disclosure, a patch feature learning method and a patch feature learning system for anomaly detection may perform the patch feature-based learning to reduce a variance of mutually similar patch features and increase a difference in mutually heterogeneous patch features. Accordingly, the patch feature learning method and the patch feature learning system according to an embodiment of the present disclosure may improve accuracy and efficiency of the anomaly detection even in a limited learning environment and enhance task processing performance accordingly.

However, the advantageous effects achieved by the present disclosure are not limited to the advantageous effects described above, and other advantageous effects that are not described above can be clearly understood from the description below.

### BRIEF DESCRIPTION OF THE DRAWINGS

FIG. 1 illustrates a block diagram of a computing system for providing a patch feature training service for anomaly detection according to an embodiment of the present disclosure.

FIG. 2 illustrates a block diagram of a computing device for providing a patch feature training service for anomaly detection according to an embodiment of the present disclosure.

FIG. 3 illustrates a block diagram of a computing device for providing a patch feature training service for anomaly detection according to an embodiment of the present disclosure.

FIG. 4 is a block flow diagram for illustrating an anomaly detection model according to an embodiment of the present disclosure.

FIG. 5 is a flowchart for illustrating a patch feature learning method for anomaly detection according to an embodiment of the present disclosure.

FIG. 6 is a flowchart for illustrating a feature representation learning method based on a patch feature according to an embodiment of the present disclosure.

FIG. 7 is a diagram illustrating an example of measuring similarity between patch features according to an embodiment of the present disclosure.

FIG. 8 is a diagram illustrating an application example of a ReConPatch process according to one embodiment of the present disclosure.

### DETAILED DESCRIPTION

The present disclosure may be modified in various ways, and may have various embodiments. Therefore, specific embodiments will be illustrated in the drawings, and will be described in detail in the detailed description. Advantageous effects and features of the present disclosure as well as methods for achieving the advantageous effects and the features of the present disclosure will become clear with reference to an embodiments described in detail below along with the drawings. However, the present disclosure is not limited to an embodiments disclosed below, and may be implemented in various forms. In the following embodiments, terms such as “first” and “second” are not used in a limiting sense, and are used to distinguish one component from another component. In addition, singular expressions include plural expressions unless the context clearly indicates otherwise. Furthermore, terms such as “including” and “having” indicate the presence of a feature or a component described in the specification, and do not preclude a possibility of adding one or more other features or components. In addition, for convenience of description, sizes of the components in the drawings may be exaggerated or reduced. For example, for convenience of description, a size and a thickness of each component illustrated in the drawings are illustrated in any desired way. Therefore, the present disclosure is not necessarily limited to illustrated examples.

Hereinafter, embodiments of the present disclosure will be described in detail with reference to the accompanying drawings. When the embodiments are described with reference to the drawings, the same reference numerals will be assigned to the same or corresponding components, and repeated description thereof will be omitted.

### System for Providing Patch Feature Training Service for Anomaly Detection

Hereinafter, a system for providing or realizing a patch feature training service for anomaly detection, which performs patch feature-based learning on a predetermined pretrained model, based on an image data set for an anomaly detection target, according to exemplary embodiments of the present disclosure will be described in detail with reference to the accompanying drawings.

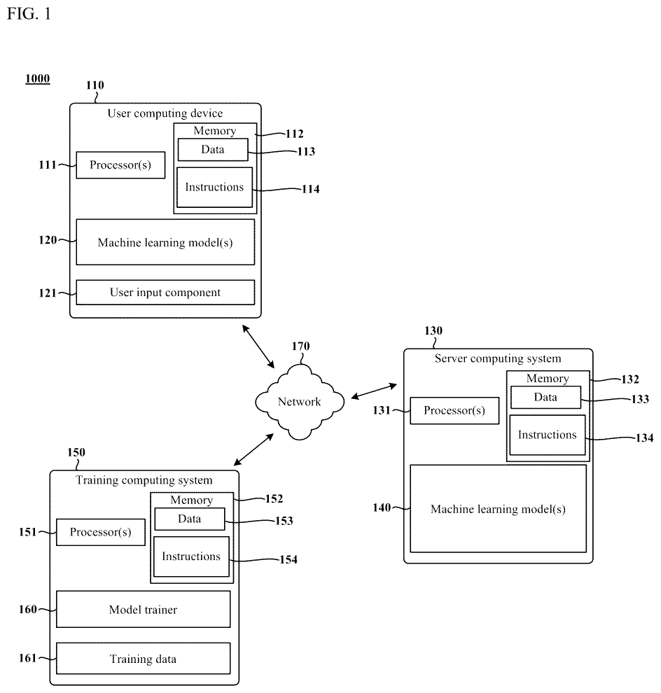

FIG. 1 illustrates a block diagram of a computing system for providing a patch feature training service for anomaly detection according to an embodiment of the present disclosure.

Referring to FIG. 1, a computing system or a computer system 1000 for providing a patch feature training service for anomaly detection according to an embodiment of the present disclosure includes a user computing device or a user computer 110, a server computing system or a server computer 130, and a training computing system a training computer 150. One or more of devices or systems included in the computing system 1000 may communicate with each other via a network 170.

A patch feature learning method for anomaly detection according to an embodiment of the present disclosure may be 1) implemented and provided locally by the user computing device 110, 2) implemented and provided in a form of a web service by the server computing system 130 communicating with the user computing device 110, or 3) implemented and provided by the user computing device 110 and the server computing system 130 in conjunction with each other.

In an embodiment, the user computing device 110 and/or the server computing system 130 may train a machine learning model (such as a machine learning model 120 and/or 140) through interaction with the training computing system 150 which is communicatively connected via the network 170. The training computing system 150 may be a system separate from the server computing system 130, or may be a part of the server computing system 130.

An artificial intelligence model (e.g., an anomaly detection model or the like) may be 1) trained locally and directly by the user computing device 110, may be 2) trained in such a manner that the server computing system 130 and the user computing device 110 interact with each other through the network 170, and may be 3) trained in such a manner that a training computing system 150, which is a system separate from the server computing system 130, uses various training techniques and learning techniques. The artificial intelligence model trained by the training computing system 150 may be implemented in such a manner that the artificial intelligence model is transmitted to, provided for, and updated by the user computing device 110 and/or the server computing system 130 through the network 170.

In some embodiments, the training computing system 150 may be a part of the server computing system 130, or may be a part of the user computing device 110.

The user computing device 110 may include any type of computing devices or computers, such as a smart phone, a mobile phone, a digital broadcasting device, a personal digital assistant (PDA), a portable multimedia player (PMP), a desktop, a wearable device, an embedded computing device and/or a tablet personal computer (PC).

This user computing device 110 includes at least one processor 111 and a memory 112. The processor 111 may include at least one or a plurality of electrically or communicationally connected processors such as a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors and/or other electrical units for performing functions.

The memory 112 may include one or more non-transitory and/or transitory computer-readable storage media, such as a RAM, a ROM, an EEPROM, an EPROM, a flash memory device, and a magnetic disk, and combination thereof, and may include a web storage of a server that performs a storage function of the memory on the Internet. The memory 112 may store data 113 and commands 114 which can be executed by at least one of the processors 111 to perform functional operations, such as training an artificial intelligence model or performing the anomaly detection through the artificial intelligence model.

In one embodiment, the user computing device 110 may store at least one machine learning model 120.

In detail, the machine learning model 120 may be various machine learning models, such as a plurality of neural networks (for example, a deep neural network), other types of machine learning models including a non-linear model and/or a linear model, and combination thereof.

The neural network may include at least one of feed-forward neural networks, recurrent neural networks (for example, long short-term memory recurrent neural networks), convolutional neural networks, and/or other types of neural networks.

In one embodiment, the user computing device 110 may receive at least one machine learning model 120 from the server computing system 130 via the network 170, may store the machine learning model 120 in the memory 112, and thereafter, may cause the processor 111 to execute the stored machine learning model 120 to perform the anomaly detection.

In another embodiment, the server computing system 130 may include or store at least one machine learning model 140, may perform one or more operations using the machine learning model 140, and may provide a patch feature training service for the anomaly detection to a user in association with the user computing device 110 by communicating related data with the user computing device 110.

For example, the server computing system 130 provides an output for a user's input by using the machine learning model 140 via the web. and the user computing device 110 may perform the patch feature training service for the anomaly detection.

In addition, when implementing the artificial intelligence model, some of the machine learning models (e.g., machine learning models 120 and/or 140) are executed by the user computing device 110 and the remaining learning models are executed by the server computing system 130.

In addition, the user computing device 110 may include at least one input component 121 configured to receive or detect a user's input. For example, the user input component 121 may include a touch sensor (e.g., a touch screen and a touch pad) configured to detect a touch of a user's input medium (e.g., a finger or a stylus), an image sensor configured to detect a user's motion input, a microphone configured to detect a user's voice input, a button, a mouse, and/or a keyboard. In addition, the user input component 121 may include an interface and an external controller when receiving an input for the external controller (for example, a mouse and/or a keyboard) through the interface.

The server computing system 130 includes at least one processor 131 and memory 132. The processor 131 may include at least one or a plurality of electrically connected processors such as a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors and/or other electrical units for performing functions.

The memory 132 may include one or more non-transitory and/or transitory computer-readable storage media, such as a RAM, a ROM, an EEPROM, an EPROM, a flash memory device, a magnetic disk, and a combination thereof. The memory 132 may store data 133 and commands 134 which can be executed by the processor 131 to perform functional operations, such as training the artificial intelligence model or performing the anomaly detection through the artificial intelligence model.

In one embodiment, the server computing system 130 may be implemented to include at least one computing device or computer. For example, the server computing system 130 may be implemented to operate a plurality of computing devices in accordance with a sequential computing architecture, a parallel computing architecture, or a combination thereof. In addition, the server computing system 130 may include the plurality of computing devices connected via the network 170.

In addition, the server computing system 130 may store at least one machine learning model 140. For example, the server computing system 130 may include a neural network and/or other multi-layer non-linear models as the machine learning model 140. An exemplary neural network may include feedforward neural networks, deep neural networks, recurrent neural networks, and convolutional neural networks.

The training computing system 150 includes at least one processor 151 and a memory 152. The processor 151 may include at least one or a plurality of electrically connected processors such as a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors and/or other electrical units for performing functions.

The memory 152 may include one or more non-transitory and/or transitory computer-readable storage media, such as a RAM, a ROM, an EEPROM, an EPROM, a flash memory device, a magnetic disk, and a combination thereof. The memory 152 may store data 153 and commands 154 which can be executed by the processor 151 to perform the learning of the artificial intelligence model.

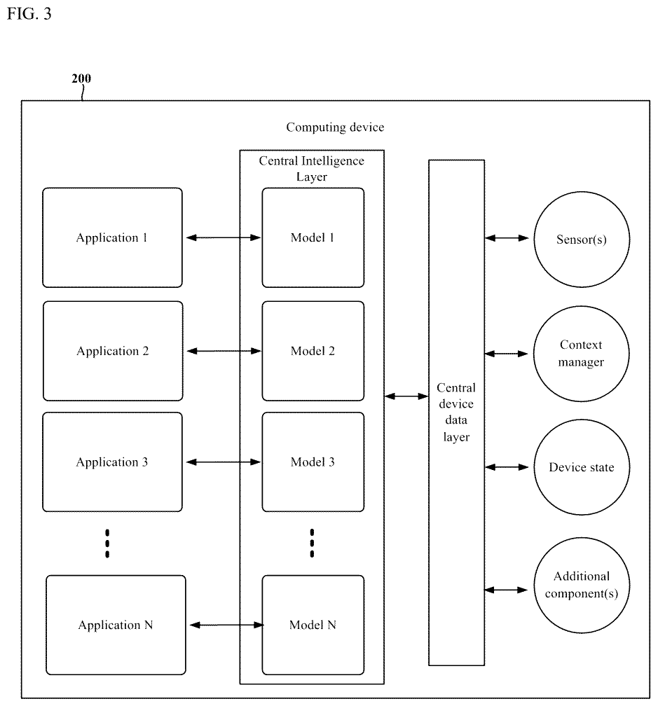

For example, the training computing system 150 may include a model trainer 160 configured to train the machine learning model (e.g., machine learning models 120 and/or 140) stored in the user computing device 110 and/or the server computing system 130 by using various training or learning techniques, such as backpropagation of errors (according to a framework illustrated in FIG. 3).

As an example, the model trainer 160 may update one or more parameters of the machine learning model (e.g., machine learning models 120 and/or 140) by using a method of the backpropagation based on a defined loss function.

In some examples, performing the backpropagation of errors may include performing truncated backpropagation through time. The model trainer 160 may perform several generalization techniques (for example, weight reduction, dropout, and/or knowledge distillation) to improve generalization ability of the trained machine learning model (e.g., machine learning models 120 and/or 140).

In particular, the model trainer 160 may train the machine learning model (e.g., machine learning models 120 and/or 140) based on training data 161. Here, for example, the training data 161 may include data in different formats, such as images, audio samples, and/or text. Examples of types of the images that can be included in the training data 161 include a video frame, a LiDAR point cloud, an X-ray image, computed tomography scan, a hyperspectral image, and/or various other forms of images.

The training data 161 may be provided by the user computing device 110 and/or the server computing system 130. When the training computing device 150 trains the machine learning model (e.g., machine learning models 120 and/or 140) on specific data of the user computing device 110, the machine learning model (e.g., machine learning models 120 and/or 140) may be characterized as a personalized model.

The model trainer 160 includes a computer logic utilized to provide a desired function.

In addition, the model trainer 160 may be implemented as hardware, firmware, and/or software, which control a general-purpose processor. In one implementation, the model trainer 160 may include a program file stored in a storage device, may be loaded into the memory 152, and may be executed by one or more of the processors 151. In another implementation example, the model trainer 160 includes one or more sets of computer-executable data 153 and the commands 154 which are stored in a tangible computer-readable storage medium, such as a RAM hard disk or an optical or magnetic medium.

The network 170 includes, for example, but not limited to, the 3rd Generation Partnership Project (3GPP) network, the Long Term Evolution (LTE) network, the World Interoperability for Microwave Access (WIMAX) network, the Internet, the Local Area Network (LAN), the Wireless Local Area Network (LAN), the Wide Area Network (WAN), the Personal Area Network (PAN), the Bluetooth network, the satellite broadcasting network, the analog broadcasting network, and/or the Digital Multimedia

Broadcasting (DMB) network.

In general, communication over the network 170 may be performed by using any type of wired and/or wireless connection, through various communication protocols (for example, TCP/IP, HTTP, SMTP, and/or FTP), encodings or formats (for example, HTML and/or XML), and/or protection schemes (for example, VPN, Secure HTTP, and/or SSL).

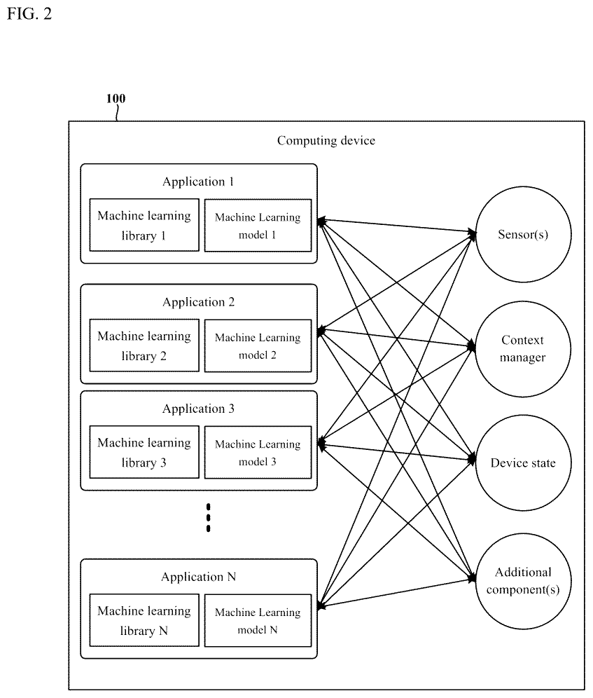

FIG. 2 illustrates a block diagram of a computing device for providing a patch feature training service for anomaly detection according to an embodiment of the present disclosure.

Referring to FIG. 2, the computing device 100, which may be included in the user computing device 110, the server computing system 130, and/or the training computing system 150, includes multiple applications (for example, Application 1 to Application N). Each application may include a machine learning library and one or more machine learning models. For example, the applications may include an application for image processing (for example, detection, classification, and/or segmentation of images), a text messaging application, an email application, a dictation application, a virtual keyboard application, a browser application, and/or a chat-bot application.

In an embodiment, the computing device 100 may include the model trainer 160 for training the artificial intelligence model, and may store and operate the trained artificial intelligence model to provide output data according to predetermined input data (e.g., image data or the like).

For example, each application of the computing device 100 may communicate with other multiple components of the computing device 100, such as at least one sensor, a context manager, a device state component, and/or additional components. In one embodiment, each application may communicate with each device component by using an Application Programming Interface (API) (for example, a public API). In one embodiment, the API used by each application may be specific to the corresponding application.

FIG. 3 illustrates a block diagram of a computing device 100 for providing patch feature training service for anomaly detection according to an embodiment of the present disclosure.

Referring to FIG. 3, a computing device or computer 200 includes multiple applications (for example, Application 1 to Application N). Each application may communicate with a central intelligence layer. For example, the applications may include an image processing application, a text messaging application, an email application, a dictation application, a virtual keyboard application, and/or a browser application. In one embodiment, each application may communicate with the central intelligence layer (and an internally stored model) by using an API (for example, a common API across all applications).

The central intelligence layer may include multiple machine learning models. For example, as illustrated in FIG. 3, one or more machine learning models may be provided to each application, and may be managed by the central intelligence layer. In another embodiment, two or more applications may share one single machine learning model. For example, in some implementation examples, the central intelligence layer may provide a single model to all or multiple applications. In some implementation examples, the central intelligence layer may be included in an operating system of the computing device 300, or may be differently implemented.

The central intelligence layer may communicate with a central device data layer. The central device data layer may be a centralized data repository for the computing device 300. As illustrated in FIG. 3, for example, the central device data layer may communicate with other multiple components of the computing device 200, such as one or more sensors, a context manager, a device state component, and/or additional components. In some examples, the central device data layer may communicate with each device component by using an API (for example, a private API).

The techniques described herein may refer to servers, databases, software applications, and other computer-based systems, as well as taken actions and information transmitted to or from systems. It will be appreciated that inherent flexibility of the computer-based systems allows a wide range of possible configurations, combinations, task division, and functionality between and from components. For example, the processes described herein may be implemented by using a single device or component, or multiple devices or components operated in combination. Databases and applications may be implemented in a single system or in a system distributed across multiple systems. Distributed components may be sequentially operated, or may be operated in parallel.

### Anomaly Detection Model (ODM)

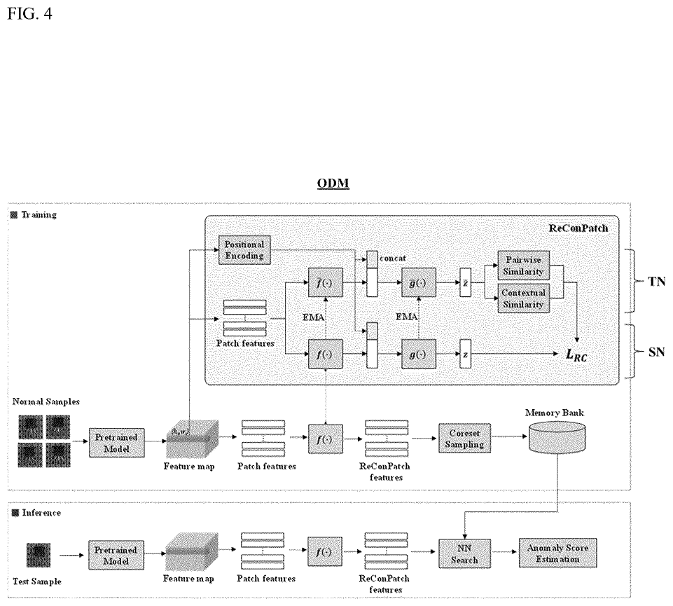

FIG. 4 is a block flow diagram for illustrating an anomaly detection model (ODM) according to an embodiment of the present disclosure.

Referring to FIG. 4, an anomaly detection model (ODM) according to an embodiment of the present disclosure may mean, for example, but not limited to, an image deep-learning model that performs anomaly detection based on a predetermined input image and classifies and/or recognizes an image based on the anomaly detection.

For instance, the anomaly detection may mean a process of identifying abnormal patterns, anomalies, and/or exceptions from specific data.

That is, the anomaly detection may be a process of detecting components that deviate from attributes of normal data.

As an embodiment, the anomaly detection may be implemented by grouping predetermined data into clusters and considering points that deviate from the clusters as anomalies.

Therefore, in an embodiment, the anomaly detection model (ODM) may determine whether a predetermined input image includes a specific abnormal attribute, and may classify and/or recognize the image in accordance with a determination result.

For example, in an embodiment, the anomaly detection model (ODM) may include the plurality of networks such as a first network (e.g., Teacher Network (TN)) and a second network (e.g., Student Network (SN)).

The first network TN according to an embodiment may mean a neural network that calculates similarity between predetermined features (e.g., patch features in an embodiment).

In an embodiment, the first network TN may include a first feature representation layer \tilde{ƒ}(⋅) and a first space projection layer \tilde{g}(⋅).

Here, a feature representation layer according to an embodiment may mean a layer that reconstructs or adjusts a feature to improve performance of feature representation according to a predetermined feature (e.g., a patch feature in an embodiment).

For this purpose, the feature representation layer may be trained to accurately extract a meaningful feature from the predetermined feature (e.g., a patch feature in an embodiment) and to reconstruct or adjust the feature based on the extracted meaningful feature.

The space projection layer according to an embodiment may mean a layer that projects feature representation according to a predetermined feature (e.g., a patch feature in an embodiment) into a predetermined feature representation space.

In an embodiment, the space projection layer may be trained to project the feature representation according to the predetermined feature (e.g., a patch feature in a embodiment) into the feature representation space to which a goal of model learning may be more effectively applied.

Meanwhile, the second network SN according to an embodiment may mean a neural network that implements feature representation learning.

For reference, the feature representation learning may mean a process in which a deep-learning model automatically detects and learns a useful feature from given data.

Through the feature representation learning, the deep-learning model may effectively encode useful information included in data to generate a meaningful feature that may be used in various deep-learning tasks, may understand complex structures and pattern of data, and may more accurately perform prediction based on this understanding.

In an embodiment, the second network SN implementing the feature representation learning as described above may include a second feature representation layer ƒ(⋅) and a second space projection layer g(⋅).

In this case, the first feature representation layer \tilde{ƒ}(⋅) and the second feature representation layer ƒ(⋅) and the first space projection layer \tilde{g}(⋅) and the second space projection layer g(⋅) according to an embodiment are intended to distinguish and describe the feature representation layer and the space projection layer which are included in the first network TN and the feature representation layer and the space projection layer which are included in the second network SN. Therefore, the description of the feature representation layer and the space projection layer of the first network TN described above may be applied to the feature representation layer and the space projection layer of the second network SN.

In addition, the first network TN and the second network SN according to an embodiment will be described in more detail in the following embodiments of a patch feature learning method for anomaly.

Meanwhile, in an embodiment, the anomaly detection model (ODM) may perform various functional operations required for a patch feature training service for anomaly detection in conjunction with a pretrained model (hereinafter, a pretrained model) to perform concept learning.

Here, the pretrained model according to an embodiment may be an image deep-learning model pretrained to perform the concept learning based on a predetermined training data set (for example, a predetermined natural image data set and/or a predetermined normal image data set).

For reference, the concept learning may mean a process of inferring general rules, concepts, or patterns from given data and classifying results.

In an embodiment, the pretrained model may be an image deep-learning model that uses a predetermined image as input data, learns common features of objects or patterns in the input image, groups image components having similar features based on the common features, and supports classifying or recognizing a specific image based on a grouping result.

(1) The pretrained model may extract a feature map for a predetermined input image.

For example, the pretrained model may automatically extract the feature map based on raw pixel data of the input image by using a predetermined image deep-learning neural network (for example, a convolutional neural network (CNN)).

The feature map may represent various visual attributes of the image, such as edges, colors, and/or textures.

(2) The pretrained model may perform clustering based on a feature space.

For instance, the pretrained model may classify the input image and/or an object in the input image into groups having similar features based on the feature map extracted as described above.

In an embodiment, the pretrained model may classify the extracted feature map according to the feature space by using a predetermined clustering algorithm (for example, K-means, DBSCAN, and/or a hierarchical clustering algorithm) or a dimensionality reduction algorithm (for example, t-SNE and/or UMAP).

(3) The pretrained model may assign a label to each cluster.

For example, the pretrained model may define a concept (hypothesis) representing each cluster, and may set the concept as a label for the cluster.

The pretrained model may learn features of images belonging to a specific concept or category by manually or semi-automatically assigning the label for each cluster.

(4) The pretrained model may verify and adjust the assigned hypothesis.

For instance, the pretrained model may verify a concept (a clustered feature group) initially defined as described above, and may adjust the corresponding hypothesis when necessary.

The pretrained model may perform a process of detecting and improving incorrectly clustered data by using new image data.

(5) In addition, the pretrained model may repeatedly perform operations (1) to (4) described above.

The pretrained model may be trained to continuously improve the clustered feature-related concept through new image data and additional feedback, and to more accurately classify or recognize the images.

In an embodiment, the pretrained model may be included in the anomaly detection model (ODM), or may be implemented as a separate device and/or server from the anomaly detection model (ODM).

In the following description, an example in which the pretrained model is implemented as a part of the anomaly detection model (ODM) will be described, but the present disclosure is not limited thereto.

Referring to FIG. 4, an embodiment in which an anomaly detection model (ODM) includes one or more of the above-described components to prevent obscurity of the features will be described. However, in other embodiments, other general computer components may be further included in addition to the components illustrated in FIG. 4 or one or some of the components illustrated in FIG. 4 may be omitted.

### Patch Feature Learning Method for Anomaly Detection

Hereinafter, a method for providing a patch feature training service for anomaly detection, which performs patch feature-based learning on a predetermined pretrained model, based on an image data set for an anomaly detection target, according to an embodiment of the present disclosure will be described in detail.

The patch feature learning method for anomaly detection of the computing system 1000 according to an embodiment of the present disclosure may improve performance and quality of various anomaly detection-based services by using the anomaly detection model (ODM) trained according to an embodiment of the present disclosure.

The patch feature learning method for the anomaly detection of the computing system 1000 according to an embodiment of the present disclosure may effectively provide the anomaly detection model (ODM) having improved performance by performing the patch feature-based learning that reduces mutually similar patch features and increases a difference in mutually heterogeneous patch features.

Hereinafter, the patch feature learning method for the anomaly detection according to an embodiment of the present disclosure will be described in more detail with reference to the accompanying drawings.

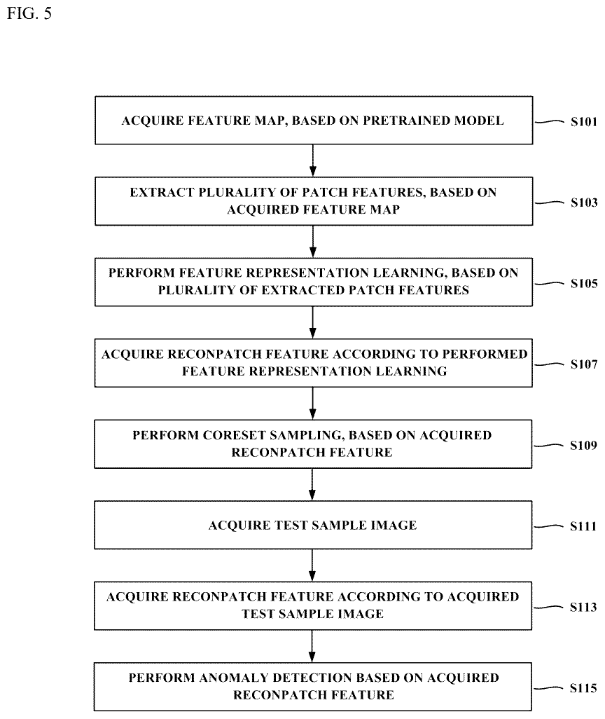

FIG. 5 is a flowchart for describing a patch feature learning method for anomaly detection according to an embodiment of the present disclosure.

Referring to FIG. 5 with reference to FIG. 4, a patch feature learning method for anomaly detection according to an embodiment of the present disclosure includes step S101 of acquiring a feature map based on the pretrained model, step S103 of extracting a plurality of patch features based on the acquired feature map, step S105 of performing feature representation learning based on the plurality of extracted patch features, step S107 of acquiring a reconstructing patch (ReConPatch) feature according to the performed feature representation learning, step S109 of performing coreset sampling based on the acquired ReConPatch feature, step S111 of acquiring a test sample image, step S113 of acquiring the ReConPatch feature according to the acquired test sample image, and step S115 of performing the anomaly detection based on the acquired ReConPatch feature.

Specifically, at step 101, the computing system 1000 according to an embodiment of the present disclosure may acquire a feature map based on a pretrained model.

In an embodiment, the computing system 1000 may acquire the feature map according to an image data set (hereinafter, a target image data set) for a predetermined anomaly detection target through the pretrained model to perform concept learning.

For example, the pretrained model according to an embodiment may be an image deep-learning model pre-trained to perform the concept learning based on a predetermined training data set (for example, a predetermined natural image data set and/or a predetermined normal image data set).

In an embodiment, the computing system 1000 may acquire the feature map based on the predetermined target image data set (e.g., an image data set including a plurality of images for the predetermined anomaly detection target) in conjunction with the pretrained model as described above.

In detail, in an embodiment, the computing system 1000 may input a target image data set (for example, an image data set including a plurality of images of a predetermined electronic circuit element) to the pretrained model.

In this embodiment, the pretrained model may output the feature map according to the input target image data set, and may provide the feature map to the computing system 1000.

Accordingly, the computing system 1000 may acquire the feature map according to the target image data set.

At step S103, the computing system 1000 may extract a plurality of patch features based on the acquired feature map.

Here, the patch feature may mean, for example, but not limited to, a feature extracted from a patch representing a small portion of a predetermined image.

For instance, the patch may be a rectangular region representing a specific portion in the predetermined image. The patch may be regarded as a subset including some of information of the entire image, and may primarily include local information or texture information.

In addition, the feature may be feature information extracted from the predetermined image or the patch, and may summarize or represent important attributes of the image (for example, patterns, textures, colors, and/or shapes).

Therefore, the patch feature may be data representing local attributes within the predetermined image in units of the patch.

In detail, in an embodiment, the computing system 1000 may extract a plurality of patch features based on the feature map acquired as described above.

More specifically, in an embodiment, the computing system 1000 may divide a target training image (hereinafter, referred to as a target training image) included in a target image data set into units of a predetermined patch size before inputting the target training image to the pretrained model described above.

The computing system 1000 may input each divided patch to the pretrained model to acquire the feature map corresponding to each patch.

In other words, the computing system 1000 may acquire the feature map for each patch by dividing the target training image into units of a predetermined patch size and inputting the divided image to the pretrained model.

According to an embodiment, the computing system 1000 may perform coreset sampling on the feature map for each acquired patch.

Here, the coreset sampling may be one of methods for processing a large-scale data set, and may include a process of extracting a set of representative samples that preserve statistical characteristics or structures of an original data set as much as possible while reducing a size of the data set.

In an embodiment, the computing system 1000 may perform the coreset sampling by using an approximate algorithm method for selecting some samples that may represent the entire data set while maintaining the characteristics of the original data set within a predetermined error range in view of the distribution of the given data.

In another embodiment, the computing system 1000 may perform the coreset sampling by using an importance sampling method for assigning a sampling probability based on importance of each given data point and preferentially selecting a data point having high importance.

Accordingly, the computing system 1000 may acquire a plurality of patch features on which the coreset sampling is performed.

Meanwhile, in another embodiment, the computing system 1000 may acquire the feature map for the entire region of the target training image (hereinafter, an entire feature map).

The computing system 1000 may divide the acquired entire feature map into units of a predetermined patch size.

Accordingly, the computing system 1000 may extract the plurality of patch features from the target training image.

In this way, in an embodiment, the computing system 1000 may extract the plurality of patch features according to the target training image by using at least one of the above-described methods.

According to an embodiment, the computing system 1000 may extract each patch feature by aggregating surrounding feature vectors within a specific patch size.

According to another embodiment, the computing system 1000 may use a pixel value itself within each patch as a feature.

According to still another embodiment, the computing system 1000 may use a statistical summary (for example, a mean, a variance, and/or a histogram) of the pixel value in each patch as a feature.

According to yet another embodiment, the computing system 1000 may analyze a texture pattern in each patch, and may use the texture pattern as a feature. For example, the computing system 1000 may extract a texture-based patch feature by using techniques of Gabor filters, Local Binary Patterns (LBP), and/or Histogram of Oriented Gradients (HOG).

According to still another embodiment, the computing system 1000 may automatically learn and extract a high-dimensional feature in each patch by using a deep-learning algorithm such as a convolutional neural network (CNN), and may use the high-dimensional feature as a feature.

In this way, the computing system 1000 may extract a feature in a patch level, and may support the anomaly detection using the extracted feature. Additionally, the computing system 1000 may improve processing efficiency in a process of data learning and analysis, and may more minutely detect an abnormal local pattern that mainly appears in a small portion in the image.

At step S105, the computing system 1000 may perform feature representation learning based on the plurality of extracted patch features.

Here, the feature representation learning may comprise a process in which the deep-learning model (e.g., an anomaly detection model (ODM) in an embodiment) automatically detects and learns a useful feature from given data.

In an embodiment, the computing system 1000 may learn the feature representation for the plurality of extracted patch features based on the anomaly detection model (ODM).

The computing system 1000 may perform the feature representation learning for the anomaly detection model (ODM) that performs the anomaly detection based on the plurality of extracted patch features.

Here, the anomaly detection may include a process of identifying abnormal patterns, anomalies, and/or exceptions from specific data, for example, a process of detecting components that deviate from attributes of normal data.

Therefore, in an embodiment, based on the plurality of extracted patch features, the computing system 1000 may perform the feature representation learning (e.g., concept learning or the like in an embodiment) to determine whether a predetermined input image includes a specific abnormal attribute and classify and/or recognize an image in accordance with the determination result.

For instance, the computing system 1000 in an embodiment may perform the feature representation learning based on a semi-supervised learning method.

In other words, the computing system 1000 may build the anomaly detection model (ODM) that implements semi-supervised anomaly detection.

Here, the semi-supervised learning may comprise a deep-learning method for training a model by using both data having a label (e.g., supervised data) and data having no label (e.g., unsupervised data).

When basic data for building an anomaly detection system is collected, i a sufficient amount of abnormal data (e.g., image data obtained by imaging an abnormal state of an anomaly detection target in an embodiment) may be required for smooth learning and highly accurately recognizing abnormal states (anomalies) of various shapes.

Therefore, an embodiment of the present disclosure may implement semi-supervised anomaly detection that builds a pretrained model by mainly using normal data (for example, image data obtained by imaging the normal state of an anomaly detection target) and performs the anomaly detection based on a pseudo label by using the pretrained model.

Here, the pseudo label may be, for example, but not limited to, a label predicted by a model trained on data having no label.

The pseudo label may be mainly used when data having a designated label is limited or when model training is performed by additionally using a large amount of data having no label.

Through this configuration, the computing system 1000 may easily achieve model learning and performance improvement for building an anomaly detection process even when data having the designated label is relatively rare or is diverse and limited.

In an embodiment, the computing system 1000 may perform the feature representation learning according to the plurality of patch features based on the first network TN and the second network SN of the anomaly detection model (ODM).

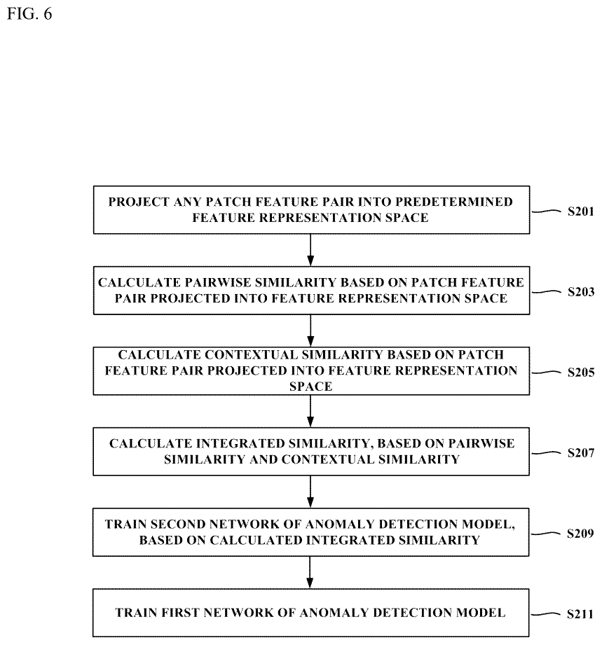

FIG. 6 is a flowchart for illustrating a feature representation learning method based on a patch feature according to an embodiment of the present disclosure.

Referring to FIG. 6, at step S201, the computing system 1000 may project a patch feature pair into a predetermined feature representation space.

In an embodiment, the computing system 1000 may project the patch feature pair (hereinafter a “first patch feature pair”) including a pair of a first patch feature pᵢ and a second patch feature pⱼ into the feature representation space.

The computing system 1000 may represent the first patch feature pᵢ projected into the feature representation space as expressed in Mathematical Formula 1(a) below, and may represent the second patch feature pⱼ projected into the feature representation space as expressed in Mathematical Formula 1(b) below.

$$\overline{{z}_{i}} = \overline{g} ( \overline{f} ( {p}_{i} ) ) \qquad [ Mathematical Formula 1 ( a ) ]$$

$$\overline{{z}_{j}} = \overline{g} ( \overline{f} ( {p}_{j} ) ) \qquad [ Mathematical Formula 1 ( b ) ]$$

At step S203, the computing system 1000 may calculate pairwise similarity based on the patch feature pair projected into the feature representation space.

Here, the pairwise similarity according to an embodiment may be data obtained by measuring the similarity between the first patch feature pᵢ and the second patch feature pⱼ which are included in the patch feature pair.

In an embodiment, the computing system 1000 may measure the pairwise similarity representing the similarity between the first patch feature Pᵢ and the second patch feature pⱼ which are included in the first patch feature pair.

For example, the computing system 1000 may calculate the pairwise similarity using Mathematical Formula 2 below.

$${ω}_{ij}^{Pairwise} = {e}^{- ‖ {z}_{i} - {z}_{j} ‖ 2} 2 / σ \qquad [ Mathematical Formula 2 ]$$

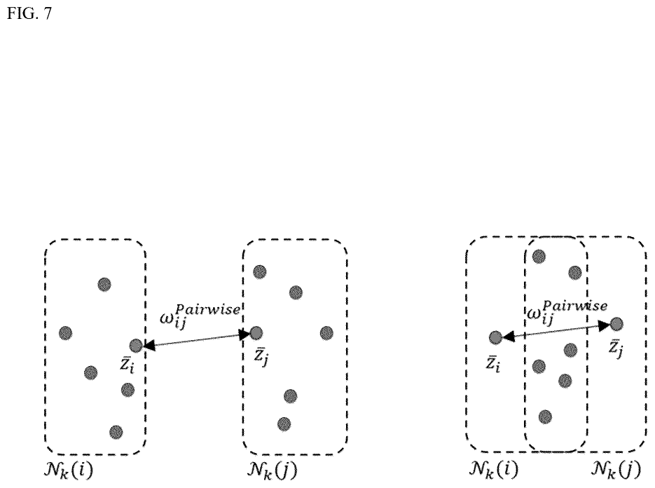

FIG. 7 is a diagram illustrating an example of measuring similarity between patch features according to an embodiment of the present disclosure.

Referring to FIG. 7, when similarity is measured only for a relationship between the first patch feature pᵢ and the second patch feature pⱼ which are included in a patch feature pair, the pairwise similarity is the same. However, discrimination accuracy may be degraded when the first feature and the second feature need to be classified as different labels as in (a) of FIG. 7 (that is, as both are further separated from each other, both are closer to a correct label) and when the first feature and the second feature need to be classified as the same label as in (b) of FIG. 7 (that is, as both are closer to each other, both are closer to the correct label).

In other words, when only the pairwise similarity is measured, the accuracy may be degraded since the label is predicted without considering mutual similarity in a group relationship including the K-number of nearest neighbors (Nₖ(i)) for the first patch feature pᵢ and the K-number of nearest neighbors (Nₖ(j)) for the second patch feature pⱼ.

At step S205, the computing system 1000 may calculate contextual similarity based on the patch feature pair projected into the feature representation space.

Here, the contextual similarity according to an embodiment may mean data obtained by measuring bidirectional similarity between the K-number of nearest neighbors (Nₖ(i)) for the first patch feature pᵢ and the K-number of nearest neighbors (Nₖ(j)) for the second patch feature pⱼ which are included in a patch feature pair.

In an embodiment, the bidirectional similarity may be calculated based on average similarity between the K-number of features of the nearest neighbors (Nₖ(i)) for the first patch feature pᵢ and the K-number of features of the nearest neighbors (Nₖ(j)) for the second patch feature pⱼ.

For example, the computing system 1000 may calculate the contextual similarity according to a K-Nearest Neighbors (K-NN) algorithm that performs prediction, based on a distance between data points using Mathematical Formulas 3 and 4 below.

$${{z}^{`}}_{ij}^{Contexual} = \{ \begin{matrix}\frac{\vert {N}_{k} ( i ) ⋂ {N}_{k} ( j ) \vert}{\vert {N}_{k} ( i ) \vert} , & ifj ∈ {N}_{k} ( i ) \\ 0 , & otherwise\end{matrix} \qquad [ Mathematical Formula 3 ]$$

$${R}_{k} ( i ) = \{ j \vert j ∈ {N}_{k} ( i ) and i ∈ {N}_{k} ( j ) \} \qquad [ Mathematical Formula 4 ]$$

$${\hat{w}}_{ij}^{Contexual} = \frac{1}{\vert {R}_{\frac{k}{2}} ( i ) \vert} {\sum }_{l ∈ {R}_{\frac{k}{2}} ( i )} {\tilde{w}}_{lj}^{Contexual}$$

Accordingly, in an embodiment, the computing system 1000 may calculate a contextual similarity which is considered to be higher as the first patch feature pᵢ and the second patch feature pⱼ which are included in the first patch feature pair share a larger number of nearest neighbors in common.

In this way, the computing system 1000 may learn the feature representation in a group relationship including the first patch feature pᵢ and the second patch feature pⱼ, and may reflect the feature representation in a pseudo label prediction process.

Therefore, the computing system 1000 may extract the K-number of the nearest feature samples of the first patch feature pᵢ and the second patch feature pⱼ, may calculate the contextual similarity that measures how many samples intersect with each other, and may use the contextual similarity together with the pairwise similarity to train the anomaly detection model (ODM). By this operation, the computing system 1000 may enable the trained anomaly detection model (ODM) to extract better quality features.

Accordingly, the computing system 1000 may more accurately determine when the pairwise similarity between the first feature and the second feature is the same, but the first feature and the second feature need to be classified as different labels (that is, when both are closer to the correct label as both have to be further separated from each other) and when the first feature and the second feature need to be classified as the same label (that is, when both are closer to the correct label as both have to be closer to each other), and may reflect this determination in the pseudo label prediction. Therefore, the computing system 1000 may directly improve task processing quality and performance of the anomaly detection model (ODM) that performs the semi-supervised anomaly detection.

At step S207, the computing system 1000 may calculate integrated similarity based on the pairwise similarity and the contextual similarity which are calculated as described above.

Here, the integrated similarity according to an embodiment may mean data obtained by combining the pairwise similarity and the contextual similarity between the first patch feature pᵢ and the second patch feature pⱼ which are included in a patch feature pair.

In an embodiment, the computing system 1000 may linearly combine the pairwise similarity and the contextual similarity between the first patch feature pᵢ and the second patch feature pⱼ which are included in the first patch feature pair using Mathematical Formula 5 below.

$${w}_{ij}^{Contexual} = \frac{1}{2} ( {\hat{w}}_{ij}^{Contexual} + {\hat{w}}_{ji}^{Contexual} ) . \qquad [ Mathematical Formula 5 ]$$

$${w}_{ij} = α \cdot {w}_{ij}^{Pairwise} + ( 1 - α ) \cdot {w}_{ij}^{Contextual} .$$

The integrated similarity according to an embodiment may be defined as a linear combination of two similarities satisfying α∈[0,1].

At step S209, the computing system 1000 may train the second network SN of the anomaly detection model (ODM) based on the calculated integrated similarity.

In an embodiment, the computing system 1000 may train the second network SN to implement the feature representation learning by using the integrated similarity.

The computing system 1000 may train the second network SN by applying the integrated similarity calculated for the first patch feature pair to a relaxation contrast loss L_{RC}.

Here, the relaxation contrast loss L_{RC} according to an embodiment may be calculated using Mathematical Formula 6 below.

$${L}_{RC} ( z ) = \frac{1}{N} {\sum }_{i - 1}^{N} {\sum }_{j - 1}^{N} {{w}_{ij} ( {δ}_{ij} )}^{2} + \frac{1}{N} {\sum }_{i - 1}^{N} {\sum }_{j - 1}^{N} ( 1 - {w}_{ij} ) {max ( m - {δ}_{ij} , 0 )}^{2} \qquad [ Mathematical Formula 6 ]$$

Here, ‘z’ in Mathematical Formula 6 may be an embedding vector inferred by ‘g(ƒ(p))’, ‘N’ may be the number of mini-batch (e.g., the number of patch instances), ‘m’ may be a repelling margin, and ‘wᵢⱼ’ may be a parameter for determining the weight of attraction and repelling loss terms.

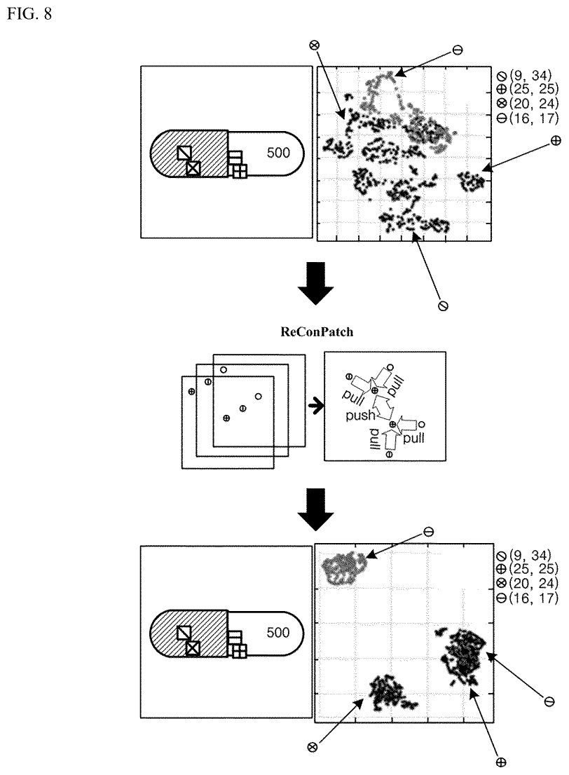

FIG. 8 is a diagram illustrating an application example of a ReConPatch process according to an embodiment of the present disclosure.

Referring to FIG. 8, in an embodiment, when the computing system 1000 determines the first patch feature pᵢ and the second patch feature pⱼ to be classified as a patch feature pair with different labels (hereinafter, a “positive feature pair”) through the integrated similarity, the computing system 1000 may train the second feature representation layer (ƒ(⋅), an embedding function) of the second network SN to map the first patch feature pᵢ and the second patch feature pⱼ which are included in the positive feature pair while being separated from each other in the feature representation space.

On the other hand, in an embodiment, when the computing system 1000 determines the first patch feature pᵢ and the second patch feature pⱼ to be classified as a patch feature pair with the same label (hereinafter, a “negative feature pair”) through the integrated similarity, the computing system 1000 may train the second feature representation layer (ƒ(⋅), an embedding function) of the second network SN to map the first patch feature Pᵢ and the second patch feature Pⱼ which are included in the voice feature pair while being closer to each other in the feature representation space.

Accordingly, the computing system 1000 in an embodiment may train the second feature representation layer pⱼ to reduce a variance of the similar patch features and increase a difference in heterogeneous patch features.

The computing system 1000 may train the second feature representation layer ƒ(⋅) to extract any patch feature in a form closer to the correct pseudo label.

Therefore, in the embodiment, the computing system 1000 may train the second feature representation layer ƒ(⋅) to more accurately extract a meaningful feature from any patch feature. Additionally, the computing system 1000 may directly improve the feature representation performance of the anomaly detection model (ODM), and may improve processing quality of various tasks (e.g., anomaly detection or the like in an embodiment) based on the improved feature representation performance.

In addition, at step S211, the computing system 1000 that trains the second network SN based on the integrated similarity in an embodiment may train the first network TN of the anomaly detection model (ODM).

In an embodiment, the computing system 1000 may gradually distill data according to a parameter θ_{ƒ,g} of the second network SN into data according to a parameter θ_{ƒ,g} of the first network TN by using an exponential moving average (EMA) method according to Mathematical Formula 7 below.

$$θ {--}_{f , g} ← γ \cdot θ {--}_{f , g} + ( 1 - γ ) \cdot {θ}_{f , g} \qquad [ Mathematical Formula 7 ]$$

Therefore, in an embodiment, the computing system 1000 may train the first network TN of the anomaly detection model (ODM) by gradually distilling information learned in the second network SN into the first network TN using Mathematical Formula 7 above.

In an embodiment, the computing system 1000 may train the first network TN described above by further applying an update rate control variable which is a variable that controls a rate of information distillation.

Accordingly, the computing system 1000 may implement the feature representation learning based on the plurality of patch features based on the first network TN and the second network SN of the anomaly detection model (ODM).

Therefore, in an embodiment, the computing system 1000 may perform a process (e.g., the ReConPatch process in an embodiment) of building a discriminant feature for the anomaly detection by distilling main features of the data set for the anomaly detection target into the pretrained model based on the semi-supervised learning as described above.

Accordingly, the computing system 1000 may build a high-performance anomaly detection model (ODM) trained to more accurately classify the corresponding feature into the correct pseudo label in a predetermined patch level.

Therefore, the computing system 1000 may directly and effectively improve the processing performance and quality of various tasks (e.g., the anomaly detection or the like in an embodiment) using the anomaly detection model (ODM).

Referring back to FIG. 5, at step S107, the computing system 1000 may acquire the ReConPatch feature according to the performed feature representation learning.

Here, the ReConPatch feature according to an embodiment may mean a patch feature output through a feature representation layer (hereinafter a “ReConPatch layer”) on which the feature representation learning described above is performed.

In an embodiment, the ReConPatch feature may be a patch feature output based on the second feature representation layer ƒ(⋅) of the second network SN on which the feature representation learning is performed.

In detail, in an embodiment, the computing system 1000 may acquire the ReConPatch feature for each target training image included in the target image data set in conjunction with the ReConPatch layer.

For instance, in an embodiment, the computing system 1000 may acquire a ReConPatch feature data set (hereinafter a “ReConPatch learning data set”) in a form of reducing the variance of the similar patch features and increasing the difference in the heterogeneous patch features for the plurality of patch features extracted from each target training image.

At step S109, the computing system 1000 may perform the coreset sampling based on the acquired ReConPatch feature.

Here, the coreset sampling according to an embodiment may be one of methods for efficiently processing a large-scale data set, and may comprise a process of extracting a set of representative samples that preserve statistical characteristics or structures of the original data set as much as possible while reducing the size of the data set.

In one embodiment, the computing system 1000 may perform the coreset sampling by using an approximate algorithm method for selecting some samples that may represent all of the ReConPatch learning data sets while maintaining characteristics of the original ReConPatch learning data set within a predetermined error range by considering the distribution of the acquired ReConPatch learning data sets.

In another embodiment, the computing system 1000 may perform the coreset sampling by using an importance sampling method for assigning a sampling probability based on importance of each acquired ReConPatch feature data and preferentially selecting a data point having high importance.

Accordingly, the computing system 1000 may acquire a ReConPatch learning data set (hereinafter a “ReConPatch sampling data set”) on which the coreset sampling is performed.

In addition, in an embodiment, the computing system 1000 may store and manage the acquired ReConPatch sampling data set on a predetermined database.

Through this configuration, the computing system 1000 may highly accurately detect the anomaly while reducing data processing costs.

At step S111, the computing system 1000 may acquire a test sample image.

Here, the test sample image according to an embodiment may be an image for detecting whether or not anomaly is present, for example, image data obtained by imaging the anomaly detection target.

In an embodiment, the computing system 1000 may acquire the test sample image as described above based on a predetermined user input and/or conjunction with an external server.

At step S113, the computing system 1000 may acquire the ReConPatch feature according to the acquired test sample image.

In the following description, any repeated content related to the embodiments described above may be summarized or omitted.

In an embodiment, the computing system 1000 may input the acquired test sample image to the pretrained model.

The computing system 1000 may acquire the feature map for the test sample image from the pretrained model to which the test sample image is input. Detailed description thereof refers to the description of Step S101 described above.

In addition, the computing system 1000 may extract the plurality of patch features based on the acquired feature map. Detailed description thereof refers to the description of Step S103 described above.

Additionally, the computing system 1000 may input the plurality of extracted patch features to the ReConPatch layer described above.

The ReConPatch layer can output the plurality of ReConPatch features according to the plurality of input patch features.

Accordingly, in an embodiment, the computing system 1000 may acquire a ReConPatch feature data set (hereinafter a “ReConPatch target data set”) in a form of reducing the variance of the similar patch features and increasing the difference in the heterogeneous patch features for the plurality of input patch features.

At step S115, the computing system 1000 may perform the anomaly detection based on the acquired ReConPatch feature.

In an embodiment, the computing system 1000 may perform the anomaly detection on the test sample image, based on the ReConPatch sampling data set acquired based on each training image used for learning and the ReConPatch target data set acquired based on the test sample image.

In other words, in an embodiment, the computing system 1000 may perform the anomaly detection on the test sample image based on the ReConPatch sampling data set and the ReConPatch target data set.

In detail, in an embodiment, the computing system 1000 may calculate similarity (hereinafter “anomaly detection similarity”) between at least a portion of the ReConPatch sampling data set stored in the database and the ReConPatch target data set.

In addition, in an embodiment, the computing system 1000 may generate an anomaly score map based on the calculated anomaly detection similarity.

Here, the anomaly score map may be an indicator that indicates how much the anomaly deviates from a determined normal state based on a value (score) assigned by a model.

As the score is higher according to the generated anomaly score map, the computing system 1000 may determine that the test sample image is closer to an abnormal state, and as the score is lower according to the generated anomaly score map, the computing system 1000 may determine that the test sample image is closer to a normal state.

Accordingly, in an embodiment, the computing system 1000 may perform the anomaly detection on the test sample image.

Furthermore, the computing system 1000 may provide various application services by utilizing the detected anomaly information.

For example, the computing system 1000 may be applied to a predictive maintenance system of an industrial facility.

In this example, the test sample image may be an image captured by a sensor (for example, a thermal imaging camera, a high-resolution camera, or the like) configured to image a specific equipment component such as a motor, a turbine, or a robotic arm in a factory.

Specifically, when the computing system 1000 detects that an anomaly score of a specific component image exceeds a preset threshold, the computing system 1000 may interpret this detection as an early sign of a potential failure such as micro-cracks, overheating, or corrosion of the component.

Accordingly, the computing system 1000 may take preemptive actions, such as outputting or issuing a warning notification to an administrator, recalculating an expected remaining useful life (RUL) of the component, predicting an optimal maintenance timing point, and automatically generating a work order.

In another example, the computing system 1000 may be applied to a process optimization and automatic control system of a smart factory.

In this example, the test sample image may be an image of a product imaged on a real-time basis on a production line, such as a semiconductor wafer, an automotive body weld area, or a mixture in a pharmaceutical process.

In detail, when the computing system 1000 identifies process abnormality, such as a micro-pattern error on the wafer surface or the occurrence of pores in a welding area, through an anomaly score map, the computing system 1000 can generate a control signal that automatically adjusts the process conditions (e.g., deposition temperature, welding current, mixing ratio, etc.) that cause the abnormality, beyond judging the product as defective, and transmit the control signal to the production facility.

Through this configuration, the computing system 1000 may prevent recurrence of the same type of defects in subsequent products, and may optimize yield and stability of an entire process on a real-time basis.

As described above, in an embodiment of the present disclosure, the computing system 1000 may perform a process (e.g., the ReConPatch process in an embodiment) of building the discriminant feature for the anomaly detection by distilling the main features of the data set for the anomaly detection target into the pretrained model, based on the semi-supervised learning as described above, and may perform the anomaly detection using the anomaly detection model (ODM) learned through the ReConPatch process.

Accordingly, in an embodiment, the computing system 1000 may improve the anomaly detection performance and quality based on the anomaly detection model (ODM) according to an embodiment of the present disclosure.

As described above, a patch feature learning method and a patch feature learning system for anomaly detection according to an embodiment of the present disclosure may perform the patch feature-based learning on the predetermined pretrained model, based on the image data set for the anomaly detection target. Accordingly, the patch feature learning method and the patch feature learning system for anomaly detection according to an embodiment of the present disclosure may perform more efficient data processing and provide the anomaly detection model (ODM) that further improves the task processing performance and quality for the anomaly detection.

In addition, a patch feature learning method and a patch feature learning system for anomaly detection according to an embodiment of the present disclosure may performs the patch feature-based learning to reduce the variance of the mutually similar patch features and increase the difference in the mutually heterogeneous patch features. Therefore, the patch feature learning method and the patch feature learning system for anomaly detection according to an embodiment of the present disclosure may improve accuracy and efficiency of the anomaly detection even in a limited learning environment and enhance the task processing performance accordingly.

Meanwhile, some embodiments according to the present disclosure described above may be implemented in a form of a program command that may be executed through various computer components, and may be recorded on a computer-readable recording medium. The computer-readable recording medium may include a program command, a data file, a data structure alone or in combination with each other. The program command recorded on the computer-readable recording medium may be specially designed and configured for the present disclosure, or may be known and available to those skilled in the art in a field of computer software. Examples of the computer-readable recording medium include magnetic media such as hard disks, floppy disks, and magnetic tapes, optical recording media such as CD-ROMs and DVDs, magneto-optical media such as floptical disks, and hardware devices specially configured to store and execute the program command, such as a ROM, a RAM, and a flash memory. Examples of the program command include not only machine language codes such as those generated by a compiler, but also high-level language codes that may be executed through a computer by using an interpreter or the like. The hardware device may be changed with one or more software modules to perform processing according to the present disclosure, and vice versa.

The specific implementation examples described in the present disclosure are exemplary embodiments, and do not limit the scope of the present disclosure in any way. For brief description of the specification, description of electronic components, control systems, software, and other functional aspects of the systems in the related art may be omitted. In addition, line connections or connection members between components illustrated in the drawings merely represent functional connections and/or physical or circuit connections as examples. The line connections or the connection members may be replaced, or may be represented as various additional functional connections, physical connections, or circuit connections in actual devices. In addition, unless specifically stated as “essential” or “important”, an element may not be absolutely required for the application of the present disclosure.

In addition, although the present disclosure has been described with reference to preferred embodiments of the present disclosure, it will be understood by those skilled in the art or having ordinary knowledge in the art that the present disclosure may be corrected and modified in various ways within the scope that does not depart from the concept and the technical idea of the present disclosure as set forth in the appended claims. Therefore, the technical scope of the present disclosure should not be limited to the contents described in the detailed description of the specification, but should be defined by the appended claims.

Forms for embodying the present disclosure are the same as best forms for embodying the present disclosure described above.

Some embodiments of the present disclosure may relate to a patch feature learning method and a patch feature learning system for anomaly detection, and may be used in an artificial intelligence industry. Therefore, the present disclosure has industrial applicability.

What is claimed is:

1. A patch feature learning method for anomaly detection, comprising:
acquiring a feature map according to a first image data set;
acquiring a plurality of patch features based on local data in a predetermined image, based on the acquired feature map;
performing feature representation learning based on the plurality of acquired patch features;
acquiring a reconstructing patch feature based on the performed feature representation learning; and
performing anomaly detection based on the acquired reconstructing patch feature, wherein the reconstructing patch feature is obtained by reconstructing a feature representation corresponding to the plurality of patch features in accordance with similarity calculated based on the plurality of patch features.

2. The patch feature learning method of claim 1, wherein at least one of the plurality of patch features is a feature extracted from a patch specifying at least a partial region in the predetermined image.

3. The patch feature learning method of claim 2, wherein the acquiring of the plurality of patch features includes:
acquiring a plurality of patches according to a predetermined patch size, based on a first image included in the first image data set and extracting a feature for each of the plurality of acquired patches; or
extracting features for the first image included in the first image data set and dividing the extracted features into a predetermined patch size.

4. The patch feature learning method of claim 1, wherein the performing of the feature representation learning includes performing semi-supervised concept learning.

5. The patch feature learning method of claim 4, wherein the performing of the feature representation learning includes performing the feature representation learning based on a first network, which is a neural network configured to calculate similarity between predetermined features, and a second network, which is a neural network for implementing feature representation learning.

6. The patch feature learning method of claim 5, wherein each of the first network and the second network includes a feature representation layer for reconstructing feature representation according to a predetermined feature and a space projection layer for projecting the feature representation according to the predetermined feature into a feature representation space.

7. The patch feature learning method of claim 6, wherein the performing of the feature representation learning further includes gradually distilling data according to a parameter of the second network into data according to a parameter of the first network based on an exponential moving average algorithm.

8. The patch feature learning method of claim 7, wherein the performing of the feature representation learning further includes:
projecting a first patch feature pair including a predetermined first patch feature and a predetermined second patch feature into the feature representation space; and
calculating pairwise similarity, obtained by measuring similarity between the first patch feature and the second patch feature, based on the first patch feature pair projected into the feature representation space.

9. The patch feature learning method of claim 8, wherein the performing of the feature representation learning further includes calculating contextual similarity, obtained by measuring bidirectional similarity between a K-number of nearest neighbors for the predetermined first patch feature and a K-number of nearest neighbors for the predetermined second patch feature, based on the first patch feature pair projected into the feature representation space.

10. The patch feature learning method of claim 9, wherein the performing of the feature representation learning further includes calculating integrated similarity by linearly combining the calculated pairwise similarity and the calculated contextual similarity.

11. The patch feature learning method of claim 10, wherein the performing of the feature representation learning further includes training the second network based on the calculated integrated similarity.

12. The patch feature learning method of claim 11, wherein the training of the second network includes training a second feature representation layer for mapping the predetermined first patch feature and the predetermined second patch feature to be separated or closer to each other on the feature representation space according to the integrated similarity.

13. The patch feature learning method of claim 1, wherein the performing of the anomaly detection includes acquiring a first test sample image, acquiring the reconstructing patch feature according to the acquired first test sample image, and performing the anomaly detection based on the reconstructing patch feature according to the feature representation learning and the reconstructing patch feature according to the first test sample image.

14. The patch feature learning method of claim 13, wherein the performing of the anomaly detection further includes:
generating an anomaly score map based on similarity between the reconstructing patch feature according to the feature representation learning and the reconstructing patch feature according to the first test sample image; and
performing the anomaly detection based on the generated anomaly score map.

15. The patch feature learning method of claim 13, further comprising:
performing coreset sampling on the reconstructing patch feature according to the feature representation learning; and
performing the anomaly detection based on the reconstructing patch feature on which the coreset sampling is performed.

16. The patch feature learning method of claim 1, wherein:
the first image data set includes one or more images obtained by imaging an equipment component of an industrial facility, and
the performing of the anomaly detection includes identifying a potential failure sign of the equipment component and predicting a maintenance timing point based on the identified potential failure sign of the equipment component.

17. The patch feature learning method of claim 16, wherein the predicting of the maintenance timing point includes recalculating an expected remaining useful life (RUL) of the equipment component and automatically generating a work order.

18. The patch feature learning method of claim 1, wherein:
the first image data set includes one or more images obtained by imaging a product during a manufacturing process, and
the performing of the anomaly detection includes identifying a process anomaly in the manufacturing process and generating a control signal for automatically adjusting a process condition based on the identified process anomaly.

19. A patch feature learning system for anomaly detection, comprising:
memory configured to store instructions; and
at least one processor executing the instructions stored in the memory to perform patch feature learning for the anomaly detection,
wherein the at least one processor is configured to acquire a feature map according to a first image data set; acquire a plurality of patch features based on local data in a predetermined image, based on the acquired feature map; perform feature representation learning based on the plurality of acquired patch features; acquire a reconstructing patch feature, obtained by reconstructing feature representation according to the plurality of patch features, in accordance with similarity calculated based on the plurality of patch features, based on the performed feature representation learning; and perform the anomaly detection based on the acquired reconstructing patch feature.

20. A computing device comprising:
memory configured to store instructions that are executable; and
at least one processor configured to execute the instructions including: acquiring a feature map according to a first image data set; acquiring a plurality of patch features based on local data in a predetermined image, based on the acquired feature map; performing feature representation learning based on the plurality of acquired patch features; acquiring a reconstructing patch feature, obtained by reconstructing feature representation according to the plurality of patch features in accordance with similarity calculated based on the plurality of patch features, based on the performed feature representation learning; and performing the anomaly detection based on the acquired reconstructing patch feature.
